(19) United States
(12) Patent Application Publication
(10) Pub. No.: US 2014/0032297 A1
(43) Pub. Date: Jan. 30, 2014

(54) MOBILE DEVICE MEDIATED HANDLING OF REWARD POINTS REDEEMABLE TOWARDS LOCAL TRANSPORTATION

(71) Applicants: Joerg Germann, Vancouver (CA); Jim Shepard, Vancouver (CA); Reed Clayton, North Vancouver (CA)

(72) Inventors: Joerg Germann, Vancouver (CA); Jim Shepard, Vancouver (CA); Reed Clayton, North Vancouver (CA)

(21) Appl. No.: 13/557,012

(22) Filed: Jul. 24, 2012

(51) Int. Cl. G06Q 30/02

(52) U.S. Cl. 705/14.26; 705/14.27; 705/14.33

(57) ABSTRACT

A method and system for generating, collecting and redeeming reward points. The reward points are redeemable for local transportation services such as taxi transportation. Generation comprises providing a reward code in conjunction with a receipt or bill associated with a qualifying transaction. Reward points are collected by entering the reward code into a mobile device application. A remote server tracks the collection of reward points. Reward points are shareable between users via the mobile device application. Reward points are redeemable via the application.

### CROSS-REFERENCE TO RELATED APPLICATIONS

This is the first application filed for the present technology.

### BACKGROUND

1. Field

The present technology relates generally to electronically managed consumer incentive and reward programs, and, in particular, to methods and systems for handling incentives via systems including mobile wireless communication devices.

2. Background

Various loyalty programs are used in marketing to incentivize certain desired consumer behaviours. For example, paper and plastic loyalty cards are often issued by businesses to consumers. Consumers are encouraged to collect valuable loyalty points by repeated use of the card. Coalition loyalty programs, such as the Air Miles™ program, offer incentives to customers of multiple businesses. Cross promotion is the practice of targeting customers of one product or service with the promotion of a related product. Loyalty programs and coalition loyalty programs are typically designed to appeal to as wide a range of customers as possible in order to maximize revenue and membership growth. As such, these programs are typically generic in nature.

United States Patent Application Publication No. 2011/0307318 discloses a mobile retail loyalty network which enables customers to use their mobile devices to participate in a merchant's customer loyalty program. This reduces or eliminates the need for a separate physical loyalty card or coupon for the loyalty program. However, this particular technology still suffers from several drawbacks and implementation limitations, and may not be suited for all types of loyalty programs, such as certain types of coalition loyalty programs that require a seamless integration across a vast ecosystem of merchants and partners allowing the collection and redemption of loyalty points.

Impaired driving is a significant public safety problem in many parts of the world. Many jurisdictions have imposed strong penalties for contravening impaired driving laws. One of the main reasons given for driving impaired when arrested is not wanting to pay for a taxi or alternative form of transportation. Due to increased enforcement and penalties related to impaired driving, restaurants, bars, vendors and other establishments are concerned about losing revenue due to decreased alcohol sales. These businesses are searching for solutions in which customers can consume alcohol without breaking the law.

Therefore there is a need for a method and system for handling (for example generating, collecting, sharing and/or redeeming) consumer incentives that overcomes one or more limitations of the prior art.

This background information is provided for the purpose of making known information believed by the applicant to be of possible relevance to the present technology. No admission is necessarily intended, nor should be construed, that any of the preceding information constitutes prior art against the present technology.

### SUMMARY

An object of the present technology is to provide a method and system for handling consumer incentives, particularly incentives redeemable toward local transportation services, for example taxi, limousine or public transit services. In accordance with an aspect of the present technology, there is provided a method for generating consumer loyalty incentives for distribution from a point of sale following registration of a transaction involving a consumer and a first party, the method comprising: extracting, at least in part via a Point Of Sale (POS) terminal, information associated with the transaction; obtaining a reward program member identifier; generating reward points based on the extracted information; and crediting the reward points to an online account associated with the reward program member identifier, the reward points redeemable during another transaction at another point of sale by the consumer or by a registered reward program member to whom the consumer has transferred at least some of the reward points, wherein one or more of: obtaining the reward program member identifier, generating the reward points, and crediting the reward points to the online account comprise interaction with a mobile device associated with the consumer.

In accordance with another aspect of the present technology, there is provided a method for redeeming electronically stored reward points, the method comprising: providing a user access, via a mobile device, to a reward points account held on a server; obtaining, at the mobile device, an indication of a party involved in a transaction with the user and to whom the payment is due; receiving an instruction, on the mobile device, to make a payment to said party in a designated amount; prompting for and receiving a user selection, via the mobile device, of a number of reward points stored in the account to be used for redemption toward the payment; debiting the selected number of reward points from the account; and initiating said payment of said designated amount to said party.

In accordance with another aspect of the present technology, there is provided a system for generating consumer loyalty incentives for distribution from a point of sale following registration of a transaction involving a consumer and a first party, the system comprising an incentive generation module configured to: extract, at a Point Of Sale (POS) terminal, information associated with the transaction; obtain a reward program member identifier; generate reward points based on the extracted information; and credit the reward points to an online account associated with the reward program member identifier, the reward points redeemable during another transaction at another point of sale by the consumer or by a registered reward program member to whom the consumer has transferred at least some of the reward points, wherein the incentive generation module is configured to interact with a mobile device associated with the consumer in performing one or more of: obtaining the reward program member identifier, generating the reward points, and crediting the reward points to the online account.

In accordance with another aspect of the present technology, there is provided a system for redeeming electronically stored reward points, the system comprising an incentive redemption module configured to: provide a user access, via a mobile device, to reward points held in a remote account; obtain, at the mobile device, an indication of a party involved in a transaction with the user and to whom the payment is due; receive an instruction, on the mobile device, to make a payment to said party in a designated amount; prompt for and receiving a user selection, via the mobile device, of a number of reward points stored in the account to be used for redemption toward the payment; debit the selected number of reward points from the account; and initiate said payment of said designated amount to said party.

In accordance with another aspect of the present technology, there is provided a computer program product comprising a computer readable memory storing computer executable instructions thereon that when executed by a computer perform operations for generating consumer loyalty incentives for distribution from a point of sale following registration of a transaction involving a consumer and a first party, the operations comprising: extracting, at least in part via a Point Of Sale (POS) terminal, information associated with the transaction; obtaining a reward program member identifier; generating reward points based on the extracted information; and crediting the reward points to an online account associated with the reward program member identifier, the reward points redeemable during another transaction at another point of sale by the consumer or by a registered reward program member to whom the consumer has transferred at least some of the reward points,wherein one or more of: obtaining the reward program member identifier, generating the reward points, and crediting the reward points to the online account comprise interaction with a mobile device associated with the consumer.

In accordance with another aspect of the present technology, there is provided a computer program product comprising a computer readable memory storing computer executable instructions thereon that when executed by a computer perform operations for redeeming electronically stored reward points, the operations comprising: providing a user access, via a mobile device, to a reward points account held on a server; obtaining, at the mobile device, an indication of a party involved in a transaction with the user and to whom the payment is due; receiving an instruction, on the mobile device, to make a payment to said party in a designated amount; prompting for and receiving a user selection, via the mobile device, of a number of reward points stored in the account to be used for redemption toward the payment; debiting the selected number of reward points from the account; and initiating said payment of said designated amount to said party.

### BRIEF DESCRIPTION OF THE FIGURES

These and other features of the technology will become more apparent in the following detailed description in which reference is made to the appended drawings.

FIG. 1 illustrates incentive generation in accordance with embodiments of the technology.

FIG. 2 illustrates incentive collection in accordance with embodiments of the technology.

FIG. 3 illustrates incentive sharing in accordance with embodiments of the technology.

FIG. 4 illustrates incentive redemption in accordance with embodiments of the technology.

FIG. 5 illustrates a system for incentive handling in accordance with embodiments of the technology.

FIG. 6 illustrates a method for closed-loop incentive generation, in accordance with embodiments of the technology.

FIG. 7 illustrates a system for providing closed-loop incentive generation, in accordance with embodiments of the technology.

FIG. 8 illustrates a system for reward point redemption via a computer aided dispatch system (CAD), in accordance with embodiments of the technology.

FIG. 9 illustrates a method for reward point redemption via a computer aided dispatch system (CAD), in accordance with embodiments of the technology.

FIG. 10 illustrates an example of character orientation in a holographic code provided in accordance with embodiments of the technology.

### DETAILED DESCRIPTION

### Definitions

The term “local transportation service” refers to a service by which a customer can be transported locally, for example on the order of about 1 km to about 50 km. Waiting times for transportation services are generally short, for example on the order of a few minutes to an hour in some cases. Local transportation service pickup and drop-off locations are generally readily accessible by foot or, in the case of private services, may be defined specifically by the customer. Local transportation services include private services such as taxis, limousines, water taxis, rickshaws, and the like, and public transit services such as local buses, subways, streetcars, light rail transit, ferries, cable cars, gondolas, and the like. Local transportation services are distinguished from long-haul transportation services such as airliners, long-distance buses and trains, and the like.

As used herein, the term “user” refers to a user of the technology as described herein. A user may interact with the technology at least in pat via their mobile device, for example. In various embodiments, a user may be a registered reward program member. A user is typically also, but not necessarily, a consumer. For example, a user may receive their reward points through a sharing means, rather than generating their own reward points by purchasing reward-eligible goods or services.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this technology belongs.

Embodiments of the present technology provide a method for generating consumer loyalty incentives for distribution from a point of sale upon registering a transaction involving a consumer and a first party. The first party may be a restaurant operating a computerized point of sale (POS) system, for example. The method comprises: extracting, at least in part via a Point of Sale (POS) terminal, information associated with the transaction. This information may comprise a value of the transaction. The method further comprises obtaining a reward program member identifier, for example automatically retrieved from a mobile device of the consumer as a reward program member. The method further comprises generating reward points based on the extracted information. Generation of reward points may be done automatically or upon manual entry of a reward code which is generated and provided by the POS. The method further comprises crediting the reward points to an online account associated with the reward program member identifier. The reward points are then redeemable during another transaction at another point of sale by the consumer or by a registered reward program member to whom the consumer has transferred at least some of the reward points. In addition, one or more of the above operations comprises interaction with a mobile device associated with the consumer. For example, the mobile device may be automatically recognized by a wireless communication system as belonging to a registered reward program member, and the member identifier may be obtained automatically therefrom. As another example, the mobile device may be used by the consumer to enter a reward code in order to obtain the reward points. The above method steps are typically automatically by the appropriately configured computerized POS system, or with limited operator intervention.

In some embodiments, the method for generating loyalty incentives further comprises: generating a substantially unique incentive code, based at least in part on said information associated with the transaction using a proprietary algorithm; and subsequently providing the incentive code for collection by the consumer. The incentive code may be generated within the POS or via an external server which is operatively coupled to the POS. The incentive code is useful in subsequent generation of reward points credited to the consumer.

Embodiments of the present technology provide a method for automatically generating reward program member loyalty incentives in a “closed-loop” manner, that is without requiring a user to enter reward codes. The method comprises automatically detecting the presence of a registered mobile device carried by the reward program member. The method further comprises automatically obtaining the reward program member identifier from the mobile device; automatically associating the obtained reward program member identifier with the transaction based at least in part on determination that a location of the mobile device corresponds with the transaction. The method further comprises transmitting the extracted information to a remote server; wherein the extracted information comprises the reward program member identifier and an indication of one or both of: a value of the transaction and a number of reward points to be credited to the member.

Embodiments of the present technology provide a method for overall handling of consumer loyalty incentives. The method comprises: generating a substantially unique, for example one-time use and/or encrypted, incentive code in response to a first transaction between a consumer and a first party. The substantially unique incentive code is subsequently provided to the consumer. The method further comprises subsequently receiving, from a mobile device operated by the consumer, a registration message for registering the substantially unique incentive code to an account held by the consumer. The registration message may be a machine-to-machine data message send from the mobile device to a server. The account is held on a server, such as a database server, which is remote from the mobile device. The method further comprises, in response to registration of the substantially unique incentive code, crediting the account with a number of reward points. The number may be based at least in part on the substantially unique incentive code. The method further comprises, on request of a user, automatically performing a second transaction. The second transaction comprising redeeming a second number of reward points toward a payment to a second party, such as a transportation service provider. The second number of reward points may be sufficient for the full payment, or they may be used for partial payment. The second number of reward points may be redeemed from the aforementioned account. The second number of reward points may additionally or alternatively be redeemed from another account to which said second number of reward points have been transferred, from the aforementioned account. By this last option, sharing of reward points may be enabled within the method.

Embodiments of the present technology also provide a “closed loop” method for handling reward program member loyalty incentives. The method comprises, in response to a first transaction between the member and a first party, automatically crediting an account held by the member with a number of reward points, the account held on a server in communication with the mobile device, wherein automatically crediting the account comprises: obtaining a member identifier from a mobile device carried by the member. The method further comprises obtaining an indication of a number of reward points to be credited to the member based on the transaction. The method further comprises, on request of a user, automatically performing a second transaction, the second transaction comprising redeeming a second number of reward points toward a payment to a second party, the second number of reward points redeemed from the account held by the member or from another account to which the second number of reward points have been transferred from the account held by the member.

Embodiments of the present technology provide a method for redeeming electronically stored reward points. The method comprises providing a user access, via a mobile device, to a reward points account held on a server. The method further comprises obtaining, at the mobile device, an indication of a party involved in a transaction with the user and to whom the payment is due. The method further comprises receiving an instruction, on the mobile device, to make a payment to said party in a designated amount. The method further comprises prompting for and receiving a user selection, via the mobile device, of a number of reward points stored in the account to be used for redemption toward the payment. The method further comprises debiting the selected number of reward points from the account. The method further comprises and initiating said payment of said designated amount to said party.

Obtaining the indication of the party involved in the transaction may include obtaining, from the mobile device, an identification code of that party. For example the party may be a transportation service provider or other party accepting payment based on redemption of reward points. Obtaining the identification code may comprise prompting for and receiving an entry from a mobile device user, such as a taxi or driver identification code. Obtaining the identification code may comprise retrieving an associated code from memory, for example a dispatch code which was generated during ordering of the taxi currently being paid for via reward point redemption. Initiating the payment may involve crediting another, second account with a monetary value based at least in part on the number of reward points. The second account is used for reconciling payment with the predetermined party. For example, the second account may be a bank account of a third party, such as a taxi company, or the bank account of the taxi driver. The method may further comprise generating and transmitting a confirmation message from the server to a second mobile device associated with the predetermined party. The confirmation message indicates that the second account has been credited, and may indicate the monetary value credited.

In some embodiments, a payment may be made via a computer aided dispatch system (CAD), for example located in a taxi. An example of a CAD is the Digital Dispatch System™. Reward points may be redeemed for making part or all of the payment. A mobile device may be configured to communicate directly with the CAD, for example via short-range wireless communication. Alternatively, the mobile device may communicate wirelessly with a server which is also in wireless communication with the CAD. The mobile device may directly or indirectly transmit payment details to the CAD, such as credit or debit transaction information required for payment, as would be readily understood by a worker skilled in the art. If a server mediates the payment, the server may hold the transaction account information rather than the mobile device, for security purposes. The payment information transmitted to the CAD may correspond to a payment account held by the reward program service provider. The reward program service provider also debits reward points from a designated member account, and, if necessary, collects “top-up” payment information from the mobile device.

Accordingly, in some embodiments of the present technology, a method for redeeming electronically stored reward points via the CAD further comprises establishing a wireless communication link to a computer aided dispatch system associated with a service provider to which payment is due. The method further comprises wirelessly transmitting payment information to the computer aided dispatch system.

As noted above, monetary payment is issued on the basis of reward points collected. As an accounting matter, money is generally made available to the system at least for covering such payments. Money may be provided for this purpose in one or more of a variety of ways, for example through advertising revenue, subscription fees, transaction fees and/or commission fees charged to parties issuing reward points, invoices generated on the basis of reward point redemption and payable by the parties issuing those same reward points, sponsorship by government entities, vendors, sponsors and/or special interest groups, and the like.

Embodiments of the present technology offer an integrated value chain, web-based incentive generation, collection and redemption technology solution that may be used as part of a campaign to increase customer loyalty, business revenues, corporate social responsibility, and margins, through the collection, sharing and redemption of reward points.

Embodiments of the present technology offer a habit forming, integrated, user-friendly mobile device application that enables users to collect reward points at various participating merchants, such as restaurants, and redeem the reward points toward local transportation services.

In various embodiments, the transaction which initiates reward point generation includes a purchase of food and beverage by the consumer, and the reward points are redeemed for transportation services. In some cases, the transaction may include a purchase of at least one alcoholic beverage for on-site consumption by the consumer. The present technology thereby enables an option for responsible consumption of alcohol by the consumer.

In accordance with another aspect of the present technology, there is provided a system for generating consumer loyalty incentives for distribution from a point of sale following registering a transaction involving a consumer and a first party. The system comprises an incentive generation module configured to extract, at a Point of Sale (POS) terminal, information associated with the transaction. The incentive generation module is further configured to obtain a reward program member identifier. The incentive generation module is further configured to generate reward points based on the extracted information. The incentive generation module is further configured to credit the reward points to an online account associated with the reward program member identifier. The reward points are subsequently redeemable during another transaction at another point of sale by the consumer or by a registered reward program member to whom the consumer has transferred at least some of the reward points. The incentive generation module may be embodied on a POS terminal, consumer mobile device, remote server, wireless devices configured for local communication with the consumer mobile device, or a combination thereof.

In accordance with another aspect of the present technology, there is provided a system for redeeming electronically stored reward points. The system comprises an incentive redemption module configured to provide a user access, via a mobile device, to reward points held in a remote account. The incentive redemption module is further configured to obtain, at the mobile device, an indication of a party involved in a transaction with the user and to whom the payment is due. The incentive redemption module is further configured to receive an instruction, on the mobile device, to make a payment to said party in a designated amount; prompt for and receiving a user selection, via the mobile device, of a number of reward points stored in the account to be used for redemption toward the payment. The incentive redemption module is further configured to debit the selected number of reward points from the account. The incentive redemption module is further configured to initiate said payment of said designated amount to said party. The incentive redemption module may be embodied on a POS terminal, consumer mobile device, remote server, computer aided dispatch system, wireless devices configured for local communication with the consumer mobile device, or a combination thereof.

Embodiments of the present technology provide a system for automatically handling consumer incentives. The system comprises an incentive generation module and an incentive redemption module. The incentive generation module may be embedded at least in part in a computerized POS terminal. Alternatively, the incentive generation module may comprise a first sub-module embedded in the POS terminal and a second sub-module embedded in a remote server, communicatively coupled to the POS terminal via a secure connection. The incentive generation module is configured to generate a substantially unique incentive code in response to a first transaction between a consumer and a first party. The substantially unique incentive code is subsequently provided to the consumer. The incentive redemption module is configured to receive, from a mobile device operated by the consumer, a registration message for registering the substantially unique incentive code to an account held by the consumer. The account is held on a server in communication with the mobile device. The incentive redemption module is further configured, in response to registration of the substantially unique incentive code, to credit the account with a number of reward points. The number may be based at least in part on the substantially unique incentive code. The incentive redemption module is further configured, in response to a user command, to automatically perform a second transaction. The second transaction comprises redeeming reward points held in the account toward a payment to a second party.

In some embodiments, the system for generating consumer incentives for distribution from a point of sale associated with a computerized point of sale (POS) terminal is further configured as follows. The POS terminal is configured to register a transaction involving a consumer and a first party. The system comprises a processing module and an output module. The processing module is configured to extract information associated with the transaction. The processing module is further configured to generate, for example at the POS terminal or at a remote server coupled to the POS terminal, a substantially unique incentive code, based at least in part on said information associated with the transaction. The output module is configured to provide the incentive code for collection by the consumer. The incentive code is useful in subsequent generation of reward points credited to the consumer. The reward points may be shareable and are typically redeemable during another transaction at another point of sale.

In some embodiments, the system for redeeming electronically stored reward points is further configured as follows. The system comprises a server module, a transaction module, and a confirmation module. The server module is configured to: provide account access, receive the indication of the party involved in the transaction, for example by receiving an identification code thereof, and receive the payment instructions and reward point selection. The transaction module is configured to: debit the number of reward points from the account; and credit a second account with a monetary value based at least in part on the number of reward points. The second account is for receiving payment for the predetermined party. The confirmation module is configured to generate and transmit a confirmation message to a second mobile device associated with the predetermined party. The confirmation message indicates that the second account has been credited, and may indicate the monetary value credited.

Embodiments of the present technology provide a system for automatically handling reward program member loyalty incentives in a “closed-loop” manner, for example without requiring a user to enter reward codes. The system comprises: an incentive credit module and an incentive redemption module. The incentive credit module is configured, in response to a first transaction between the member and a first party, to automatically credit an account held by the member with a number of reward points, the account held on a server in communication with the mobile device. Automatically crediting the account comprises: obtaining a member identifier from a mobile device carried by the member; and obtaining an indication of a number of reward points to be credited to the member based on the transaction. The incentive redemption module is configured, in response to a user command, to automatically perform a second transaction. The second transaction comprises redeeming reward points held in the account or held in a second account to which reward points have been transferred from the account, toward a payment to a second party.

The incentive credit module may at least partially coincide with the incentive generation module. Automatically crediting the account may comprise: automatically detecting the presence of a registered mobile device carried by the reward program member;automatically obtaining the reward program member identifier from the mobile device; automatically associating the obtained reward program member identifier with the transaction based at least in part on determination that a location of the mobile device corresponds with the transaction; and transmitting the extracted information to a remote server.

Embodiments of the present technology provide a system for generating incentives for distribution from a point of sale associated with a computerized point of sale (POS) terminal in a “closed loop” manner. The POS terminal is configured to register a transaction involving a reward program member and a first party. The system comprises a processing module, a transmission module and a server module. The processing module is configured to extract information associated with the transaction. The extracted information comprises an identifier of the member and an indication of one or both of: a value of the transaction and a number of reward points to be credited to the member. The transmission module is configured to transmit the extracted information to a remote server. The server module is associated with the remote server and is configured to credit a number of reward points to an online account of the identified member based on the extracted information. The reward points are redeemable during another transaction at another point of sale by the member or by another user to whom the member has transferred the reward points.

Embodiments of the present technology provide a system for redeeming electronically stored reward points. The system is configured to provide a user access, via a mobile device, to an account held on a server. The system is further configured to establish a wireless communication link to a computer aided dispatch system associated with a service provider to which payment is due. The system is further configured to prompt for and receive an entry, on the mobile device, of an instruction to make a payment to the service provider in a designated amount. The system is further configured to prompt for and receive a selection, on the mobile device, of a number of reward points stored in the account for redemption toward the payment. The system is further configured to debit the number of reward points from the account. The system is further configured to wirelessly transmit payment information to the computer aided dispatch system.

Embodiments of the present technology may leverage social or governmental campaigns. For example, by incentivizing users to make environmentally conscious and/or socially responsible choices, such as taking public transit or taking a taxi after drinking alcohol, embodiments of the present technology may be used to further such campaigns. This contribution of the present technology may generate reciprocal value. Reciprocal value may include, for example, sponsorship of the technology by social advocacy groups, associated individuals, and/or government agencies, and improved uptake of the technology by people who subscribe to the ideals of the campaigns.

Some embodiments of the present technology are deployed without the need for deployment of new special-purpose hardware to users and participating merchants. Rather, existing POS terminals and mobile device such as smartphones may be reconfigured through software to operate as devices in support of the present technology. These existing POS terminals and mobile devices may further interoperate with a relatively fewer number of servers, which are deployed and accessible remotely. Embodiments of the present technology may thus be integrated relatively easily with existing systems. Furthermore, communication between the servers and existing systems may be executed via existing protocols, such as SMS messages and TCP/IP packets transmitted over wireless networks.

### Incentive Generation Using Reward Codes

Embodiments of the present technology comprise incentive generation via generation of a reward code usable for collecting reward points. The reward points thus generated are subsequently redeemable for or toward select local transportation services and optionally shareable between users. The provided reward points may incentivize user behaviours such as frequenting a merchant providing the reward codes, using a local transportation service for which the reward codes are redeemable, or a combination thereof, for example using the local transportation service to return home from the merchant. The reward points may further incentivize socially desirable behaviours, such as responsible transportation choices. The collection and redemption of reward points may thus be focused toward synergistic products and/or services.

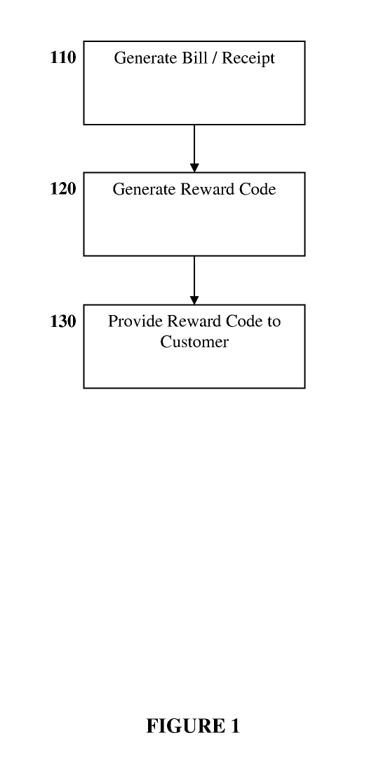

In some embodiments, and with reference to FIG. 1, the incentive may be generated as follows. A merchant's point-of-sale (POS) terminal generates 110 a bill or receipt related to a purchase by a customer. The POS terminal is typically an electronic terminal configured according to predetermined software, for example as provided by Squirrel™ Systems, Micros™, Vivonet™, POSitouch™, or the like. Generation of the bill or receipt corresponds to registration of a transaction at the POS, and triggers local or remote generation of a reward code 120. The generated reward code is subsequently provided 130 to the customer, for example by displaying on a screen, transmitting to the customer's mobile device, printing on a bill or receipt given to the customer, or the like. The reward code is subsequently usable for collection of reward points, for example by the customer.

In some embodiments, the reward code conveys and/or is a function of select information regarding the transaction at the POS. For example, the reward code may comprise an indication of a number of reward points conveyed by the reward code. The reward code may further comprise an indication of a time of the transaction, a date of the transaction, a merchant identifier, and optionally further information regarding the transaction, for example what was purchased, whether the customer has special status, a value amount of the transaction, an indication of a rate or function by which reward points are generated based on transaction particulars such as the value amount, specified time intervals during which the reward code is redeemable, or the like, or a combination thereof.

In some embodiments, at least some information regarding the transaction at the POS is substantially unrecoverable from the reward code. For example, some information such as the value amount of the transaction may be omitted from the reward code. As another example, one or more information elements, such as the merchant identifier and transaction time and date may be operated on by a predetermined many-to-one function. The output of the many-to-one function is integrated into the reward code and indicates that the merchant is an authorized merchant and that the transaction occurred during an authorized time period, but the precise merchant and transaction time and date cannot be recovered. In some embodiments, the many-to-one function may be a rounding or truncation function. Similarly, the number of reward points may be rounded, for example to the nearest 10 points, thus the precise transaction value cannot be recovered even if the rate at which reward points are generated based on transaction value is known. The information may be reversibly or irreversibly obscured by other means, as would be readily understood by a worker skilled in the art.

The reward code is generally associated with one or more tamper-resistant features, to discourage customers from attempting to or accidentally modify the reward code, use it multiple times, or the like. In some embodiments, the reward code is encrypted. In some embodiments the reward code comprises one or more error detection or correction features, as would be readily understood by a worker skilled in the art. As an example, the reward code may comprise one or more checksum digits. In some embodiments, the reward code comprises information by which the reward code may be authenticated.

In some embodiments, the reward code may be generated as follows. A transaction value (at least a portion of the monetary amount paid or to be paid to the merchant) and transaction time (for example a time and date at which the bill or receipt is generated), are extracted from the POS data. The POS may comprise a software module which is configured to automatically extract this information upon occurrence of all or selected transactions. The extracted information may then be encoded as a string or concatenation of numerical values. For example, the extracted information may be represented as data:

AAA AAA YYM MDD, (1)

where AAA AAA is a six-digit value indicating the transaction value in cents, YY is a two-digit value indicating the year of the transaction, MM is a two-digit value indicating the month of the transaction from 1 to 12, and DD is a two-digit value indicating the day of the transaction. The number of reward points may be generated as a predetermined function of the transaction value, for example 2% or 4% of the transaction value, rounded to the nearest integer. Alternatively, AAA AAA may indicate the number of reward points directly, based on the predetermined function.

The data represented in (1) may subsequently be encrypted. In one embodiment, a look-up table encryption may be used. For example, each digit of the data may be uniquely and reversibly mapped to another ‘alias’ digit. For example, the digits ‘0’ through ‘9’ may be mapped to the digits ‘5’, ‘3’, ‘7’, ‘9’, ‘6’, ‘1’, ‘4’, ‘0’, ‘2’ and ‘8’, respectively. The encrypted data may then be provided to the customer as a reward code, which is not readily decipherable or adjustable. Stronger encryption algorithms may be employed to provide increased data security, as would be readily understood by a worker skilled in the art. For example, the transaction value may be encrypted via a different algorithm than other fields, for example by double lookup table encryption. The lookup table may be adjusted periodically or selected from a plurality of lookup tables. For example, selection of the lookup table may be a function of the sum of the unencrypted data. A security code may also be added to the reward code and the digits of the reward code interdependently encrypted, such that if the encrypted reward code is entered incorrectly, the security code is invalidated.

In some embodiments, in addition to providing the reward code to the user, the POS system or the remote server which generates the reward code, may be configured to store in memory a copy of the reward code, or a copy of the data used to generate the reward code, possibly along with further transaction details. The POS system may upload the stored information periodically and/or upon request to a server. This information may be used for reconciliation, tracking and/or validation purposes. For example, stored reward codes may be compared to reward codes actually collected by customers, in order to determine the overall uptake of the reward program, to detect customer or merchant fraud, or the like.

### Incentive Collection Via Reward Codes

Once provided with the reward code, the customer may collect reward points based on the reward code. In some embodiments, the customer may alternatively pass on the reward code to another person for reward point collection. In some embodiments, the reward code may be a numeric or alphanumeric code, which the customer may manually enter into a predetermined application running on their mobile device. The mobile device may thus be considered as a mobile device configured to perform operations commensurate with operations of the application. The application may be configured to accept entry of the reward code, partially or fully process the reward code, and transmit related information to a server, communicatively coupled to the mobile device.

As an alternative to hand entry of the reward code, the user may take a picture of the code using the mobile device, speak the code to the mobile device, or the like, wherein the mobile device is configured to convert the picture or speech into the corresponding code.

In some embodiments, the reward code may be provided via a secure holographic code as described elsewhere herein. Such codes may be resistant to capturing via automatic optical scanning or photography. Rather, a user may enter such codes manually.

In some embodiments, the mobile device may communicate directly with the POS terminal, for example wirelessly and/or via near-field communications (NFC) to receive the reward code.

In some embodiments, the mobile device, the server, or both may be configured to decrypt or otherwise decipher the reward code. For example, the reverse of the above-mentioned look-up table operation may be applied to the encrypted reward code in order to recover the underlying encrypted information. In some embodiments, when the reward code comprises the transaction value rather than the number of reward points, the mobile device, the server, or both may be configured to determine the number of reward points corresponding to the transaction value, for example as 2% or 4% of the transaction value.

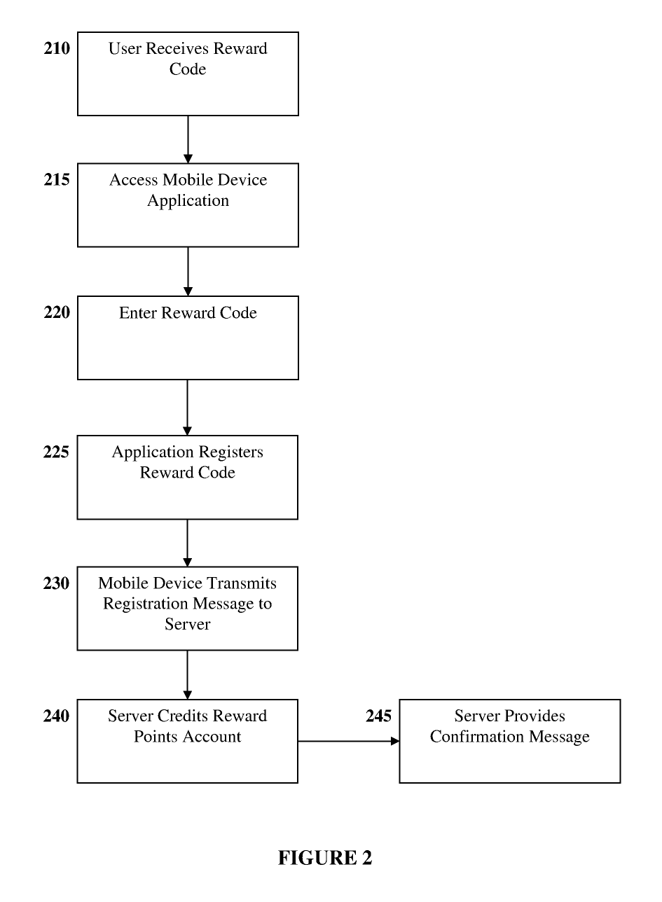

FIG. 2 illustrates collection of incentives in accordance with embodiments of the present technology. A reward code is provided 210 to a user, for example on a receipt or bill related to a recent purchase. The user accesses 215 an application on their mobile device and enters 220 the reward code into the application in an appropriate manner. The application registers 225 the entry and transmits 230 a registration message to a remote server. The registration message instructs the server to credit 240 an account associated with the user with a number of reward points based on the reward code. The server may optionally provide 245 a confirmation message that the account has been credited.

### Incentive Generation and Collection Without Reward Code Entry

In some embodiments of the present technology, incentives such as reward points may be credited directly to an identified reward program member's, without necessarily requiring a reward code to be printed and then entered by a user. Such embodiments generally comprise: detecting the presence of a registered reward program member; associating a reward point-eligible transaction with the present reward program member; automatically crediting an amount of reward points to an account of the reward program member based on the transaction details; and optionally transmitting a notification message to a mobile device of the reward program member. These steps are described in more detail below.

Detecting the presence of a registered reward program member may comprise detecting that a mobile device carried by the member has crossed into and is currently within a predetermined area, such as a restaurant or other venue from which reward point-eligible transactions may be made. Such detection may be made in accordance with various geofencing technologies, as would be readily understood by a worker skilled in the art. In some embodiments, GPS coordinates of the member's mobile device are processed locally or reported to a remote server and processed remotely to determine whether the mobile device is within a predetermined area. In some embodiments, one or more sentinel wireless devices, such as Wi-Fi™ or Bluetooth™ devices, may be deployed within the predetermined area. A Wi-Fi™ hot spot may be configured as such a sentinel wireless device. These sentinel devices may be configured to detect the presence of mobile devices as they enter the predetermined area. Upon detection, the sentinel device may query the entering mobile device to determine whether it belongs to a registered reward program member. If so, the sentinel device may retrieve a member identification code from the mobile device and transmit this to the POS system or a remote server, thereby registering the presence of the member within the system. In some embodiments, the mobile device may also transmit a message to facilitate registration.

In some embodiments, unambiguously associating the reward point-eligible transaction with a reward program member whose presence has been detected within the predetermined area may proceed as follows. The member may input, via an application running on their mobile device, that they are about to conduct a reward-eligible transaction at a POS device associated with the predetermined area. The mobile device may be configured to notify a remote server via a wireless data message (and optionally the POS device by way of the remote server), to mark the member's account to indicate a transaction is in progress. Reward points from the next reward-eligible transaction occurring within the next x minutes will then be automatically credited to that member's account.

In some embodiments, unambiguously associating the reward point-eligible transaction with a reward program member whose presence has been detected within the predetermined area may proceed as follows. The member carries their mobile device with them to the physical POS, and places it proximate to a short-range receiver such as a NFC receiver. The short-range receiver then receives a reward program member identifier from the mobile device. The POS transmits the reward program member identifier along with the transaction details. A remote server then automatically credits the member's account, associated with the member identifier, with the appropriate number of reward points.

In some embodiments, unambiguously associating the reward point-eligible transaction with a reward program member whose presence has been detected within the predetermined area may proceed as follows. The member is associated with a billing location such as a table which is in turn registered with the POS. In accordance with standard restaurant practice, the POS generates bills for each billing location, such as each table. The location of the member's mobile device is determined to sufficient accuracy and precision that the member can be unambiguously associated with a billing location. This may involve triangulation or trilateration of wireless signals within a venue such as a restaurant. Alternatively, a short-range receiver such as an NFC receiver may be located at each billing location, for example attached to the table, and detects the presence of mobile devices within the immediate area to trigger interrogation of the mobile device for a potential reward program member identifier stored therein. A reward program member identifier is also received from the mobile device and registered along with the billing location. When the POS generates a bill for that billing location, it checks the registry to determine whether a reward program member is at that billing location. If so, the POS transmits the reward program member identifier along with the transaction details. A remote server then automatically credits the member's account, associated with the member identifier, with the appropriate number of reward points.

Automatically crediting the reward member's account with reward points may comprise transmitting a message from the POS to a remote server, for from a remote transaction server to a remote account server. The message conveys instructions to credit a specified reward member account with a specified number of reward points. This may be similar to the process by which a user registers a reward code from their mobile device, except that a reward code is not necessary, nor is user input required beyond possibly responding to a verification message or indicating that they are about to conduct a reward-eligible transaction, as specified above.

In some embodiments, a notification message may be transmitted to the mobile device of a member following crediting of their account. The notification message may be initiated by a remote server, transmitted wirelessly to the mobile device as a data message, and interpreted by an application running on the mobile device or alternatively transmitted as an SMS message or other general message. In some embodiments, notifications may be enabled or disabled by user action. In some embodiments, a verification message may be used in place of a notification message.

In some embodiments, the present technology may be configured to determine an appropriate means for incentive generation and collection, and then utilize this means. The potential means for incentive generation and collection include incentive generation and collection via a user-entered reward code, as described above, and incentive generation and collection without reward code entry, as also described above. The POS terminal, or POS terminal in combination with a remote server and/or geofence, may be configured to determine the appropriate means.

For example, if no registered reward program members are detected within the venue serviced by the POS (e.g., the restaurant), then the present technology may cause a reward code to be printed on a cheque. If an unambiguous relationship is determined between a reward program member and a reward point-eligible transaction (e.g. restaurant cheque), then the present technology may cause that reward program member's account to be credited with the appropriate amount of reward points and, optionally, a message to be sent to the member indicating that their account has been credited. If there is substantial doubt or dispute regarding who is to receive reward points for a reward-eligible transaction, the present technology may cause a reward code to be printed on a cheque or may initiate an identity clarification process or a reward point sharing process.

Various reward point sharing processes may be utilized. The reward points may be credited to one or more selected reward program members, who may then share the reward points with other members as described elsewhere herein. Sharing may optionally be enforced at the server level. For example, if a member does not share at least a predetermined number of reward points with other members who are at the same location when the reward points are issued, the points are lost. Additionally or alternatively, reward points may be credited to different reward program members in a round-robin fashion. That is, each time reward points are made available through a reward point-eligible transaction, the server selects a new reward program member at the location to credit the reward points to. Additionally or alternatively, some or all of the generated reward points may be put into a virtual pot, and different reward program members may compete to win reward points from the pot. Competition may comprise entering their name into a random draw, answering trivia questions, or other means. Various mechanisms may be employed to distribute reward points with a predetermined level of fairness. For example, a third of all generated reward points may be shared equally between reward program members present at the location when the reward points are issued. As another example, a quarter of all generated reward points may be reserved and associated with reward codes printed on cheques. The remainder of the reward points may be subject to competition or arbitrary distribution. It will be understood that the above sharing mechanisms may be used as an alternative or as a complement to distributing reward points and/or reward codes to those individuals who earned them by making the reward point-eligible purchases.

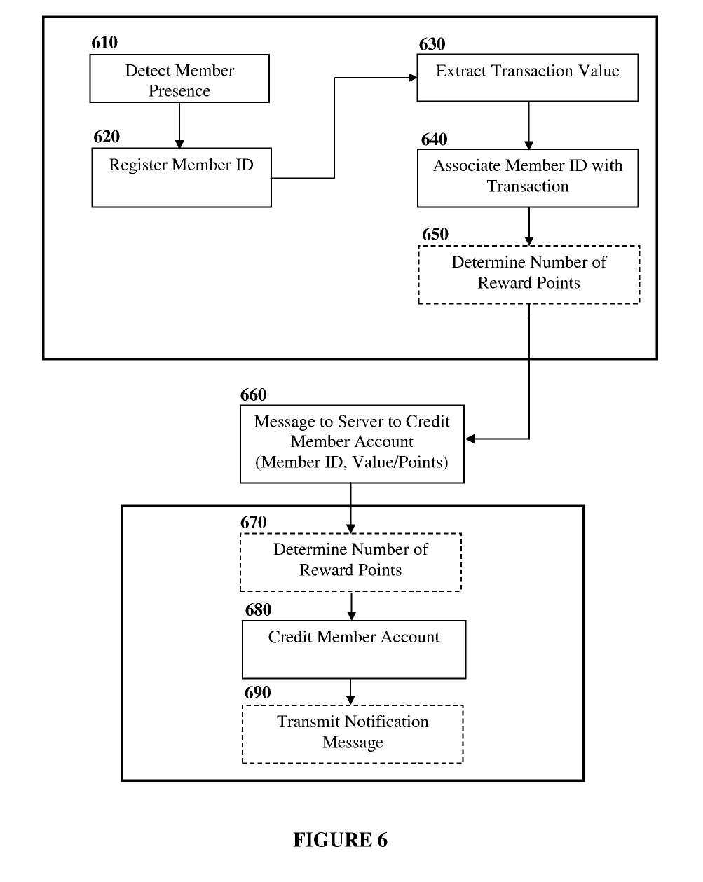

FIG. 6 illustrates a method for incentive generation in accordance with embodiments of the present technology. The method comprises automatically detecting 610 the presence of a member, for example via geofencing and/or interrogation of a member's mobile device within a predetermined area serviced by a merchant or other party providing reward points. An identifier of the member is registered 620 following detection, for example by automatically requesting the reward program member ID number from the mobile device and storing it in a computer memory. The method further comprises, following a transaction which takes place at an associated POS terminal, extracting 630 a value of the transaction, optionally along with other information such as merchant identifier, time of transaction, and the like.

The method further comprises attempting to associate 640 one of the registered member identifiers with the transaction. This step may comprise communicating with one or more members via their mobile devices in order to confirm which member identifier is to be associated with the transaction, for example. If a registered member identifier cannot be unambiguously associated with the transaction, a reward code may be provided instead, for example printed on the transaction receipt, so that the appropriate member can collect their reward points manually.

The method optionally comprises locally determining 650 a number of reward points to be credited to the member, for example within the POS terminal. For example, the number of reward points may be determined as 2% of the transaction dollar value. Alternatively, the necessary information may be transmitted to a server and this step may be performed 670 at a remote server.

The method further comprises transmitting 660 a message from the POS terminal to a remote server, the message prompting the server to initiate crediting of an indicated member's account with a number of reward points. As discussed above, the number of reward points to be credited may be explicitly provided within the message or implicit within other information, such as the transaction value.

The method further comprises automatically crediting 680 the indicated member's account with a computed number of reward points. The crediting operation may be initiated and/or performed automatically by the server. The method further optionally comprises transmitting a notification message to the member's mobile device, confirming that their reward point account has been credited.

### Incentive Sharing

Some embodiments of the present technology are configured to facilitate sharing of reward points between different people.

In some embodiments, the present technology may facilitate tracking of shared reward points. For example, a user's mobile device, a server, or both, may be configured to track whom the user has shared reward points with, when the points were shared, how many points were shared, cumulative amounts of points shared, and the like. Similarly, the user may be capable of tracking who has shared reward points with the user, as well as when and how many reward points have been shared with the user. In some embodiments, the server may track reward points sharing between users and represent same as a network, with strength of ties between the users (represented as network nodes) being a function of the reward points exchanged between the users. The network may subsequently be analyzed using network theoretic operations and the results of the analysis used for marketing or other purposes.

In some embodiments, incentives may be shared via a social networking application such as Facebook™. A tie-in application may be provided which operates within the context of the social networking application. The tie-in application may facilitate sharing of incentives between contacts in the social network. For example, the tie-in application may be configured to import contacts from the social networking application, so that reward points may be shared with those contacts via the social networking application or other channels. The tie-in application may facilitate generation of further incentives, incentive multipliers, or other marketing materials to be propagated via the social network.

In some embodiments, a user may further provide log-in or authentication credentials via an existing social networking application, when signing in to an application running on their mobile device and associated with the reward program.

In some embodiments, a user may send a request to others, such as their friends, asking them to share reward points with the user. The others may then respond to the request by sharing points with the user, or by forwarding the request on to their friends, and so on.

In some embodiments, reward points may be shared freely between users, with no requirement or expectation of reciprocity, payment, or other consideration in exchange for receiving reward points. In other embodiments, users may provide reward points to each other in exchange for other considerations. Such transactions may or may not be brokered by the present technology. In some embodiments, in return for responses to the request which result in the user receiving shared points, the user may provide some consideration, for example a promise to share points with the responder at a later time.

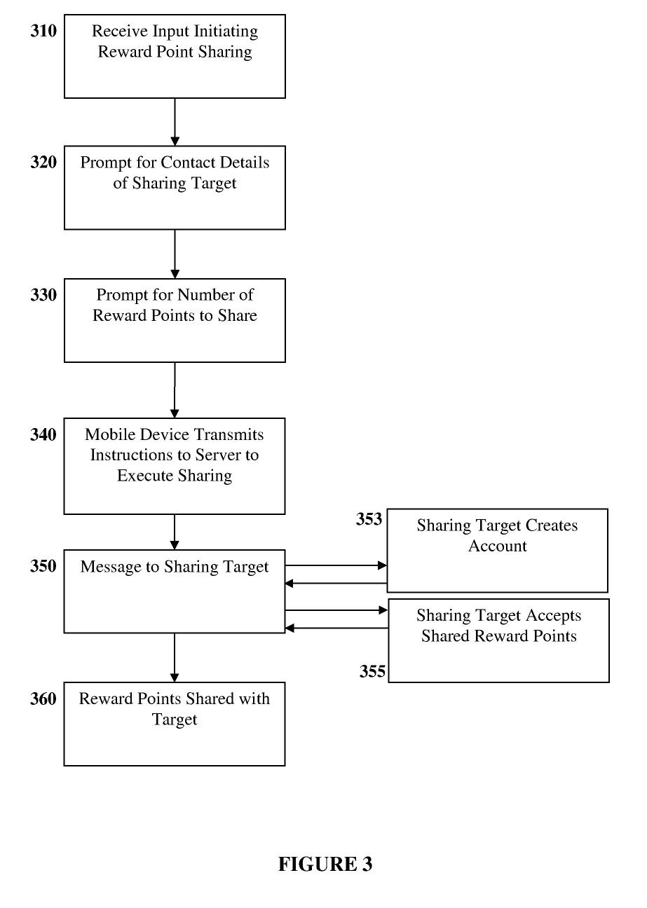

In embodiments, sharing of reward points may be initiated via an application running on a mobile device as follows, and as illustrated in FIG. 3. The application receives 310 input indicative that the user wishes to share reward points. The application then presents 320 an interface by which the user can enter contact details of the contact person with whom the reward points are to be shared. Contact details may be entered via reference to a list of locally or remotely stored contacts (including social networking contacts), for example. The application prompts 330 the user to enter a number of reward points to share, optionally along with further details such as a message or conditions. The application transmits 340 instructions to a server to debit the user's reward point account and hold the debited points for transfer. The application or the server also sends 350 a message, such as an email, SMS message or social networking message, to the contact person, indicating that reward points have been shared with them, along with instructions for accepting the shared points.

If the contact person has a reward points account, the reward points may be automatically deposited 360 therein or deposited upon acceptance 355. If the contact person does not have a reward points account, they may be given the opportunity to create one 353, and the shared reward points may then be deposited 360 into the newly created account.

Sharing may also be used when collecting the points, e.g. if customers are splitting the check and also want to split the reward points.

### Incentive Redemption

Embodiments of the present technology are configured for redemption of reward points, for example for or toward the purchase of local transportation services.

In some embodiments, reward points may be combined with other forms of payment to make up (top-up) the total amount payable to a transportation service provider. For example, the user's account may be linked to a source of funds, such as a credit card, bank account, or telecom carrier mobile payment system, or the like, such that, if the user has insufficient reward points to pay for a taxi ride, the additional funds may be applied automatically. For example, the user may enter an amount payable for transportation services, and if that amount exceeds the amount coverable by reward points, the difference may be charged to the user's credit card. The user will generally be made aware of what portion of the payment is sourced from reward point redemption and what portion is sourced from other sources.

The telecom carrier mobile payment system may operate as follows. The wireless telecommunications carrier who provides communication services for the user's mobile device may offer a credit service, operated by the carrier company themselves, by an affiliate company such as a bank, or offered by a collaboration of companies. The user may borrow funds from the credit service for topping up payments made from the mobile device, such as payments to the transportation service provider. The amount borrowed is then entered as an item on the user's telecommunication carrier account, and may be billed along with other mobile device services, such as data charges, system access, voice minutes, and the like. Service charges, interest charges, and the like, may also be applied in some cases. A mobile device application provided in accordance with the present technology may provide the option to pay via a telecom carrier mobile payment system as an integrated feature.

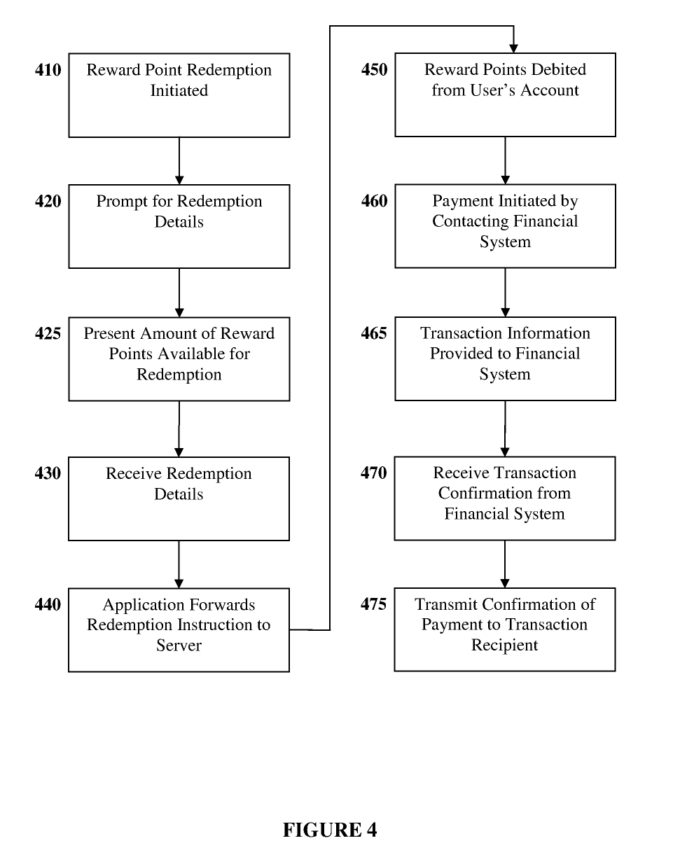

In embodiments, and with reference to FIG. 4, incentive redemption may proceed generally as follows. A predetermined application, accessible by a user on their mobile device, accepts 410 a user's indication that they wish to redeem reward points. The application then prompts 420 the user for redemption details. An amount of reward points available for redemption may also be explicitly or implicitly presented 425 to the user via the application. The application then receives 430 at least the following redemption details from the user: an amount of reward points to be used and/or an amount of money to be paid, and an identifier of the party to whom the payment is to be directed. Generally each reward point is worth a predetermined corresponding amount of money.

For example, in the case of redeeming reward points for a taxi ride, the identifier of the party may comprise an identifier of the taxi company and/or a driver or taxi cab specific identification code, which may be provided by the driver or the taxi.

The application then forwards 440 instructions to a remote incentive redemption module, for example a server thereof, for executing the reward point redemption. The instructions may direct the incentive redemption module to debit 450 a specified number of reward points from the user's account and initiate a specified payment to an account associated with the identified party. The account may be a credit card account, bank account, business bank account, or the like. Initiating payment comprises automatically contacting 460 an automated financial system via a secure communication network and providing 465 information in accordance with the requirements of the automated financial system. Data communication with secure servers of automated financial systems is performed as would be readily understood by a worker skilled in the art.

Following receipt 470 of confirmation from the financial system that the payment has been processed, the incentive redemption module is configured to generate and transmit 475 an electronic confirmation of payment the transaction recipient. The confirmation may take the form of an automated voice call, email message, SMS message, or data message, for example. The contact information may be provided to the incentive redemption module along with the payment instructions. Alternatively, the contact information may be stored by the incentive redemption module and associated with the supplied identifier of the party, for example via a lookup table or database. For example, the incentive redemption module may store taxi drivers' mobile phone numbers in association with their driver specific identification codes in a database. Taxi drivers or companies may supply this information for registration into the database.

The mobile device application is generally configured to interoperate with a remote server during reward point redemption. The server may be communicatively coupled to the mobile device via a wireless data network, as would be readily understood by a worker skilled in the art. The application may query the server for information such as the user's current reward point balance. The application further provides authentication information and instructions to the server.

In some embodiments, the party paid via reward point redemption may offer a communication channel for coupling of the application and the server. For example, the taxi may act as a wireless hotspot, which the user can access for free when redeeming reward points.

In some embodiments, payment to the transportation service provider may be made directly from the mobile device, without requiring the server to communicate with the financial system. For example, the mobile device may be configured to communicate directly with the Digital Dispatch System (CAD) provided within a taxi. Communication may be via wireless connection, NFC, or the like. The mobile device may then authenticate itself to the CAD and provide necessary payment or credit information. Payment or credit information may be retrieved from the server. In exchange for payment or credit, the server debits reward points from the appropriate user account. In this embodiment, a separate confirmation of payment may be unnecessary.

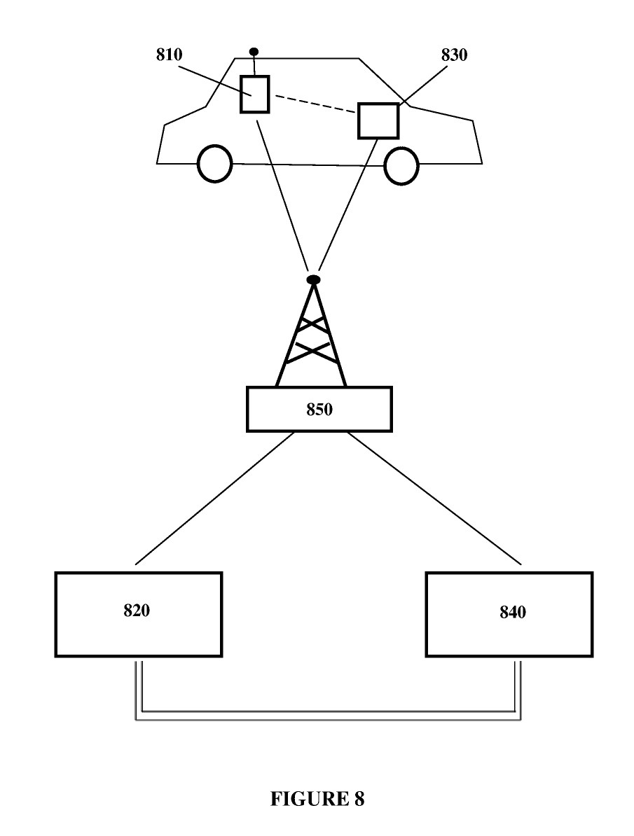

FIG. 8 illustrates a system for reward point redemption via a computer aided dispatch system, in accordance with embodiments of the technology. The system comprises a member's mobile device 810, a reward program server 820, a computer aided dispatch (CAD) system comprising a mobile CAD terminal 830 and a remote CAD server 840, and a wireless communication infrastructure 850 which may be used to communicatively coupled various system components. Although a single infrastructure is shown, different infrastructures may be provided for coupling different components. For example, the CAD system may utilize a private communication infrastructure and the mobile device may communicate via a cellular network operated by a mobile network operator. The CAD terminal 830 and CAD server 840 are communicatively coupled through the communication infrastructure 850, as would be readily understood by a worker skilled in the art.

In some embodiments, the mobile device communicates with the server 820 via the infrastructure 850 independently of the CAD system. In some embodiments, the mobile device also communicates with the CAD system via the infrastructure 850. In this case the mobile device may communicate first with the central CAD server 840 and may further communicate with the mobile CAD terminal 830 via the central CAD server. Communication via the infrastructure 850 may be via suitable secure data communication, such as encrypted packets transmitted via a wireless packet data network. For example, data may be transmitted via encrypted IP packets over a GPRS™-enabled cellular network.

In some embodiments, the reward program server 820 may be coupled to the CAD server 840 via a wired or wireless communication link. The reward program server 820 may be further coupled to the mobile CAD terminal 830 via the CAD server 840, if required.

In some embodiments, the mobile device 810 may communicate, via short-range wireless communication, with the mobile CAD terminal 830. Suitable protocols for such communication may comprise NFC communication, Bluetooth™, or Wi-Fi™, for example. The mobile device may, in some embodiments and if required, further communicate with the central CAD server 840 via its connection with the mobile CAD terminal 830.

In some further embodiments, the mobile device may utilize the communication capabilities of the CAD system to communicate with the reward program server 820. For example, messages between the mobile device 810 and the server 820 may be routed through the CAD terminal 830 and optionally through the central CAD server 840. Thus, a direct wireless communication link between the mobile device and the server may not be necessary, although such a link may be advantageous for security reasons.

The reward program server 820 and the central CAD server 840 may be computer servers, collections of servers, or virtual servers, appropriately configured as would be readily understood by a worker skilled in the art. Further, each server may be operatively coupled to one or more financial systems, account databases, or the like, as would be readily understood by a worker skilled in the art. The wireless communication infrastructure 850 may be an existing infrastructure deployed in a geographic region and capable of conveying data, as would be readily understood by a worker skilled in the art. The mobile device 810 and the mobile CAD terminal 830 may be portable computing devices capable of wireless communication via one or more long-range and optionally short-range protocols.

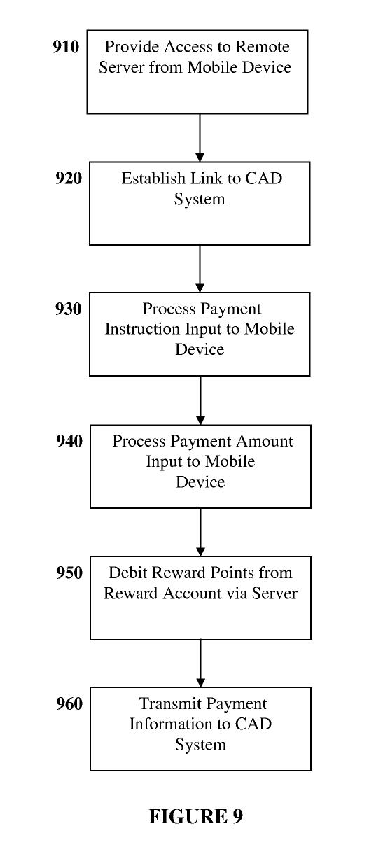

FIG. 9 illustrates a corresponding method for reward point redemption via a computer aided dispatch system, in accordance with embodiments of the technology. The method comprises providing 910 access to a remote server from a mobile device. For example, the mobile device may access the remote server via existing wireless communication infrastructure and an application running on the mobile device. The method further comprises establishing 920 a wireless communication link to the CAD system, for example via a short-range wireless communication protocol, a wireless communication infrastructure and/or via the remote server. The method further comprises processing 930 payment instructions which are input to the mobile device, for example by prompting for and receiving user input via a mobile device application. The method further comprises processing 940 a payment amount which is input to the mobile device, for example by prompting for and receiving user input via a mobile device application. The payment amount may include an indication of how many reward points are to be redeemed and optionally an amount of funds which are to be debited from a user's credit account, debit account, or the like. The method further comprises debiting 950 the reward points from the user's reward points account, via operation of the reward program server. The method further comprises transmitting 960 payment information to the CAD system, for example via a short-range wireless link between the mobile device and a mobile CAD terminal, long-range wireless link, and/or wired link between the reward program server and a CAD server.

### Integrated Collection, Sharing and Redemption

Embodiments of the present technology comprise or are implemented by a mobile device and a server, in such a manner that the user interfaces facilitating incentive collection, incentive sharing, and incentive redemption are substantially integrated into a single application operating on the mobile device. The single application may further integrate additional functionality, such as calling a taxi or displaying information related to a public transit schedule. Relevant social networking interaction, games, tip calculators, spending trackers, trip trackers, advertisements, and the like, may also be incorporated into the application.

By providing an integrated application which allows user access to a variety of related features, embodiments of the present technology provide improved ease with which incentives may be collected, shared and redeemed. This in turn may promote some or all of: uptake of the incentive program, increased business by the merchants offering the incentives and local transportation service providers offering to take the reward points as payment.

### Apparatus and System Components

Embodiments of the present technology relate to an apparatus and/or a system of apparatuses communicatively and operatively interconnected with each other.

In some embodiments, a POS terminal may be provided for generating and providing reward codes in response to a transaction. Various computerized POS terminals are known in the industry. Such POS terminals may typically be reconfigurable through software to operate in accordance with embodiments of the present technology. In some embodiments, an incentive generation sub-system comprising a POS terminal and a remote server may be provided for generating and providing reward codes in response to a transaction. The components of the sub-system may be communicatively coupled via a secure data communication link, such as a set of wired links providing a secure and encrypted Internet connection, as would be readily understood by a worker skilled in the art.

In some embodiments, a mobile device may be provided, in the possession of a user, and used to enter manage and redeem reward points. The mobile device may be a cell phone, smart phone, tablet, or other suitable consumer mobile device capable of wireless communication. Such a mobile device may typically be reconfigurable through software to operate as a user interface in accordance with embodiments of the present technology. Reconfiguration may be performed by downloading and installing an “app,” for example. Alternatively, the mobile device may be provided to the user in a pre-configured state.

In some embodiments, a server or system of servers may be provided, which are configured for communication with the mobile devices and optionally the POS terminals. The server may comprise a mobile device interface module, a database module, a processing module, a transaction module, and an optional POS interface module.

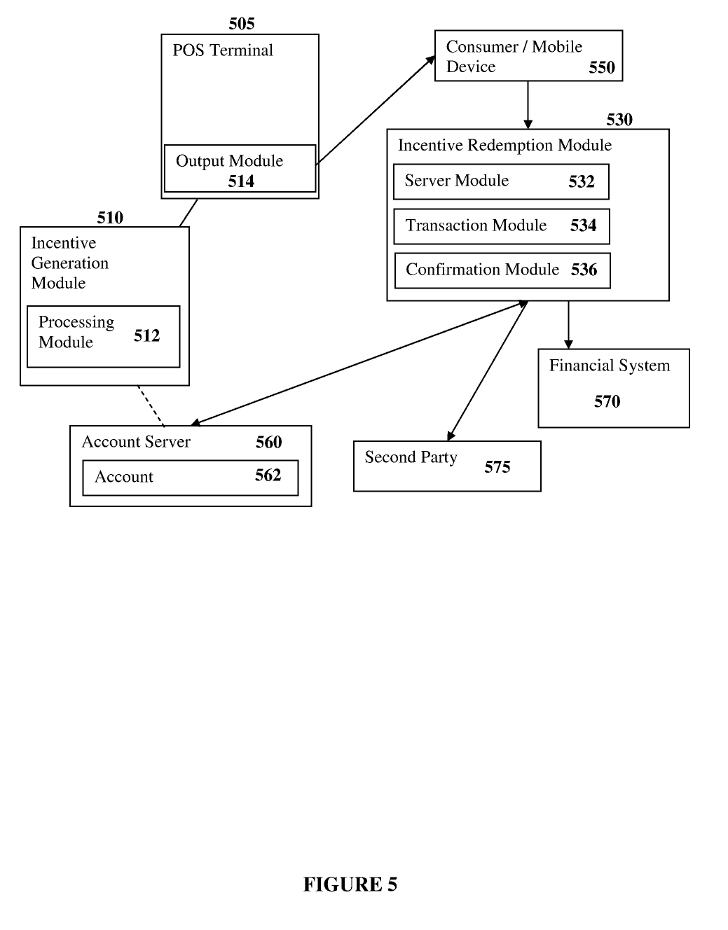

FIG. 5 generally illustrates a system provided in accordance with embodiments of the present technology. The system comprises an incentive generation module 510 and an incentive redemption module 530. The incentive generation module may be partially or fully embedded within a computerized POS terminal 505. Portions of the incentive generation module may be embedded within a remote server communicatively coupled to the POS terminal. The system further comprises or is operatively coupled to a mobile device 550 operated by a user such as a consumer. The system further comprises or is operatively coupled to an account server 560 upon which reward point accounts 562 are stored. The system is further communicatively coupled to a financial system 570 and a second party 575.

The incentive generation module 510 is configured to generate a substantially unique incentive code in response to a first transaction between a consumer and a first party. The incentive generation module 510 may itself be regarded as a system or sub-system. As illustrated, the incentive generation module 510 comprises a processing module 512 and the POS 505 terminal comprises an output module 514. The processing module 512 is configured to extract information associated with the transaction and generate a substantially unique incentive code, based at least in part on said information associated with the transaction. In some embodiments, the processing module comprises a POS processing sub-module located in the POS and a server-side processing sub-module located on a remote server. The POS processing sub-module extracts the information and provides it to the server-side processing sub-module. The server-side processing sub-module generates the incentive code, which may then be provided to the output module 514. The output module 514 is configured to provide the incentive code for collection by the consumer. The processing module may utilize computer processing components of the POS terminal. The output module may likewise use output components (e.g., receipt printing, on-screen display and/or NFC) of the POS terminal.

The incentive redemption module 530 is configured to receive, from a mobile device 550, a registration message for registering the incentive code to an account 562 held by the consumer. The account is held on an account server 560, which is communicatively coupled to the incentive redemption module. The incentive redemption module is further configured, in response to registration of the incentive code, to credit the account 562 with a number of reward points. The incentive redemption module is further configured, in response to a user command received from the mobile device 550, to automatically perform a second transaction. The second transaction comprises redeeming reward points held in the account 562 toward a payment to a second party 575.

The incentive redemption module may comprise one or more computer servers, virtual servers, databases, and the like. The servers are communicatively coupled to the mobile device, a mobile device of the second party, and optionally the incentive generation module via appropriate wired and/or wireless communication networks, as would be readily understood by a worker skilled in the art.

The incentive redemption module may be communicatively coupled to a financial system 570, which may comprise a computerized banking system, credit card system, telecom carrier mobile payment system, or the like, or a combination thereof. The financial system 570 processes the payment upon receipt of an appropriately configured and authorized message from the incentive redemption module, as would be readily understood by a worker skilled in the art.

The incentive redemption module may comprise a server module 532, a transaction module 534, and a confirmation module 536. The server module 532 is configured to provide a user access, via the mobile device 550, to an account 562 held on an account server 560. The server module 532 is further configured to receive, from the mobile device 550, an identification code of the second party 575 involved in a transaction. The server module 532 is further configured to receive, from the mobile device 550, a selection of a number of reward points stored in the account 562 for redemption toward a payment related to the transaction. The transaction module 534 is configured to: debit the number of reward points from the account 562; and credit a second account in the financial system 570 with a monetary value based at least in part on the number of reward points, the second account for receiving payment for the second party 575. The confirmation module 536 is configured to generate and transmit a confirmation message to a second mobile device associated with the second party 575, indicating that payment has occurred.

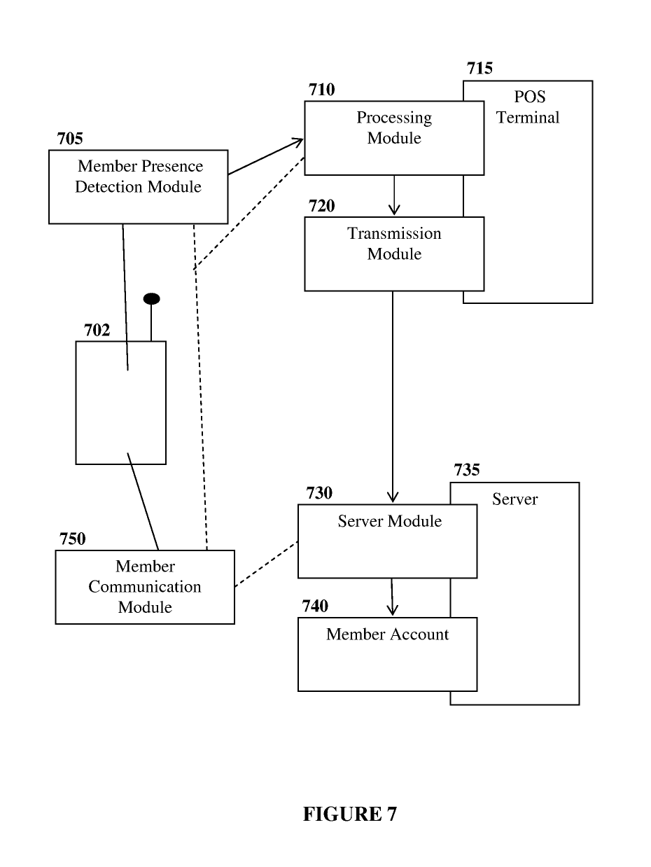

FIG. 7 illustrates a system provided in accordance with another embodiment of the present technology. The system comprises a processing module 710 module configured to extract information associated with the transaction,a transmission module 720 configured to transmit the extracted information to a remote server, and a server module 730 configured to credit a number of reward points to an identified member based on the extracted information. The processing module, the transmission module, or both, may be part of or operatively coupled to a POS terminal 715. The processing module 710 receives transaction information such as a value of the transaction from the POS terminal 715 via a data channel. The processing module further receives an identifier of a reward program member, to whom reward credit for the transaction is to be given, from a member presence detection module 705. The member presence detection module 705 may be associated with a geofencing system, such as a set of mobile device detection and interrogation devices placed around a predetermined venue perimeter, a system for tracking mobile device locations reported wirelessly to a remote server, or the like. In some embodiments, the member presence detection module is configured to detect the presence of reward program members (via presence of their mobile device 702) sufficiently local to the POS, interrogate the mobile devices for member identification information, and pass the member identification information to the processing module 710.

The server module 730 may be part of a remote server 735 communicatively coupled to the transmission module 720 via a secure data network connection. The member account 740 may be stored on the server 735 or on a different server.

In some embodiments, the system may also comprise a member communication module 750, which is configured to communicate with the member's mobile device 702. The communication module may reside at the server 735 or at another local location (for example associated with the member presence detection module) or another remote location. Communication may be routed through a public wireless network or through the member presence detection module 705. Communication with the mobile device may comprise one or more of: transmitting a confirmation message to the mobile device 702 indicative of reward points credited; and communicating with the mobile device to unambiguously associate the reward program member with a reward point-eligible transaction.

Communication between system elements may be executed via existing protocols, such as TCP/IP packet exchange over existing communications infrastructure, for example as provided by cellular service providers, wireless hotspot providers, wired or wireless internet service providers, or the like, and as would be readily understood by a worker skilled in the art.

### Secure Holographic Codes

Embodiments of the present technology comprise a holographic code, such as a numeric or alphanumeric code, which is conveyed on a hologram, such as a reflection hologram provided as a substantially thin sticker which can be securely affixed to products for purchase. The code characters are secure in that the entire code is unreadable when viewed from a single angle. For example, to interpret a first set of one or more characters, one would have to view the holographic code from a first angle, while to interpret a second set of one or more characters one would have to view the holographic code from a second angle. Interpreting all the characters in the code, in the right order, may require viewing the holographic code from two angles or more than two angles. When viewing from three or more angles is required, the viewer's eye or other optical receiver may be required to move in two dimensions rather than only along a single line.

To facilitate such security, different code characters may have different three-dimensional orientations in the hologram. Each code character may be provided within a substantially thin planar element, and different planar elements may have normal vectors which are substantially different in three-dimensional orientation. Orientations may be purposefully varied to facilitate the security. Thus, for example, from a first vantage point in which a first code character is seen as facing the viewer, a second code character may be seen edge-on, or at least at a sufficiently sharp angle that the second code character is distorted beyond ready recognition.

In some embodiments, for example, from the first vantage point, a “top” face of the second code character, being the face closest to the viewer, may obscure a significant portion of the rest of the second code character. Thus the second code character may be self-obscuring from the first vantage point. In some embodiments, other objects, such as other code characters, may obscure all or part of the second code character when viewed from the first vantage point.

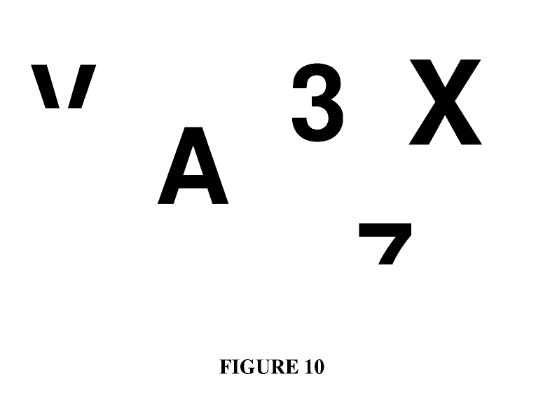

FIG. 10 illustrates an example of character orientation in a holographic code provided in accordance with embodiments of the present technology. As illustrated, the various code characters appear within the hologram to be oriented differently in three dimensions.

Such holographic codes may be used to convey reward codes in a secure manner, as described herein. Thus, a reward code may be provided on a product such as a bottle of alcohol. After purchase, a reward program member may enter the code via their mobile device and collect reward points based thereon.

It is contemplated that these secure holographic codes may have broader application than conveying the types of reward codes for use as described elsewhere herein. For example, the secure holographic codes may be used for distributing more general types of reward codes, for example by affixing them to products for purchase. The secure holographic codes may be used for distributing information other than reward codes.

Since reading the entirety of the holographic code requires viewing it from multiple angles, a single photograph of the hologram will not capture all of the code. This discourages people from attempting to illegitimately acquire reward codes, for example by entering a store and taking photographs of the code labels.

Typically, different secure holographic code may convey different sets of numeric or alphanumeric characters, although limited code re-use may be acceptable in some cases. This limits the applicability of mass production of reward codes, for example by existing stamping or embossing methods. In this case, production costs may be reduced by employing computer-generated holography, which is capable of generating holographic images without requiring a physical source object. Automated generation of holographic codes, including alphanumeric characters arrayed in a holographically three-dimensional configuration, followed by automatic printing of the generated holographic codes onto a sticker-type substrate, may facilitate lower cost production of a variety of codes.

It is known that certain instances of holograms may exhibit the divisibility property. Some potential code thieves may attempt to use this to their advantage, by tearing off pieces of secure holographic codes, expecting that they can recover the code from the torn piece. To counter this possibility, a hologram may be provided at a purposefully low resolution, such that pieces of the whole, below a certain threshold size, would appear too “blurry” to recover the code from. In various embodiments, the threshold size may be 90% of the total hologram size, 80% of the total hologram size, 50% of the total hologram size, 25% of the total hologram size, 5% of the total hologram size, or another percentage. Alternatively, since each piece of the hologram would show a different perspective, the characters in the hologram may be arranged so that at least one character is obscured by another when viewed from a given perspective or range of perspectives. Thus, to obtain the entire code, one would have to be in possession of the entire hologram or at least several pieces taken from different locations of the hologram. The practice of obscuring one character with another also makes it less likely that a single photograph of the hologram will capture the entire code contained therein.

In some embodiments, the hologram may comprise animated features for greater security. For example, when viewed from different angles, some of the characters in the holographic code may appear to smoothly move or jump from one location to another. This may facilitate the practice of obscuring one character with another.

In some embodiments, a numeric code, barcode or QR code may be used in place of a holographic code, affixed as a sticker or other accessory to a product for purchase. In some embodiments, the code may be printed on the inner side of a peel-off sticker, so that it is not viewable without removing the code from the product.

In some embodiments, a code may be secured to a substantially transparent or translucent container, such as a glass or plastic bottle, such that the code faces inward and is viewable through the walls of the container. In some embodiments, the container is filled with a liquid product such as an alcoholic beverage, which may also be transparent or translucent. In further embodiments, optical effects caused by a combination of the liquid and the container cause the code to be substantially unreadable until the liquid is consumed.

In some embodiments, entry of a code associated with a product for purchase may be restricted by geographic location. For example, if it is detected that a mobile device is within a predetermined range of a location selling such a product, an application running on the mobile device may be restricted such that entry of the code to gain reward points is inhibited. This discourages users from entering a store and scanning codes of unpurchased products to obtain reward points.

In some embodiments, if it is later determined that a user obtained and entered a reward code before purchasing the associated product, the associated reward points, plus a penalty, may be deleted from the user's account, and the user potentially banned from the reward program.

The technology will now be described with reference to specific examples. It will be understood that the following examples are intended to describe embodiments of the technology and are not intended to limit the technology in any way.

### EXAMPLES

### Example 1

The present example relates to a mobile technology based software solution is provided to compute, assign and transact an amount of reward points as a function of a transacted cash amount for cash less use in another business transaction. In the present example and elsewhere, the term “member” may be interpreted as “user.”

The present example technology involves a transaction server and SMS server that operates in the cloud (SaaS), and a mobile software application based on mobile smart phone application technology for user interaction and transactions such as collecting, sharing, gifting and redeeming reward points. One reward unit is mathematically derived from an amount of cash a reward program member spends at a restaurant or merchant partner.

For the purpose of determining and generating reward points, software is embedded into commercially available Point of Sale systems (e.g., Micros POS 3700, Squirrel etc.) of a restaurant that is a registered merchant partner. The POS software has the capability to extract the cheque amount, restaurant location and transaction date/time information from the restaurant's POS system whereby the POS software encrypts this data into a 12 digits reward code that gets printed in the trailer of the restaurant's cheque and handed to the customer. As an alternative, the POS software may provide the extracted information to a remote server and request that the server generate a reward code. The remote server computes the reward code and transmits it back to the POS for printing on the cheque. If the customer is a reward program member, the member invokes an application on the mobile smart phone and enters the reward code into the dedicated fields. A non-member would need to first sign-up for a reward program account and then enter the aforementioned reward code in the same sequence. The smart phone application communicates with the transaction server via public wireless internet (e.g., Edge, 3G, etc.) and updates and reconciles the member's reward points account data in an associated database. If the member wishes to redeem reward points, they would call, hail or online reserve a taxi that is a registered transportation partner. At the time of payment for the taxi, the member would invoke the specific redeem application on their smart phone, select the specific fare amount and the taxi driver's specific 6 digit ID code and submit the payment instruction via public wireless network using the application on his smart phone. Alternatively, the smart phone may receive the taxi driver's code from a QR code mounted in the passenger section of the taxi, or from an NFC wireless transmitter mounted in an appropriate location in the taxi proximate to the smart phone. At the moment the transaction sever receives the member's payment instruction, it processes the information, debits the member's account, credits the Taxi partner company's account with the specific transaction information and sends a SMS based payment confirmation message to the taxi driver's mobile phone via the SMS server. The reward program operator will obtain the taxi driver's phone number from the taxi corporation as part of the business agreement that requests a table showing each taxi driver, his respective taxi driver ID code (6 digits) and his mobile phone number. Alternatively, payment may be made via the CAD (computer aided dispatch system such as the Driver Dispatch System™) with taxi, as described elsewhere herein. Should the member not have a sufficient amount of reward points in their account they can automatically increase their account by debiting a debit or credit account, such as a payment card, for example a Visa credit card that is included as an option during registration and stored and encrypted in accordance with PCI and PADS S standards. Additionally or alternatively, the member can utilize a telecom carrier mobile payment system for taxi fare top-up, or other appropriate system of payment top-up.

In some embodiments, an application running on the member's mobile device may also be configured to allow the member to order a taxi using that application. In this case, information generated during the taxi ordering process may be re-used in place of the taxi driver's code. Therefore, the member does not need to enter the taxi driver's code as part of the payment process. For example, during the taxi ordering process, a dispatch code may be generated which is associated with the particular taxi or taxi driver providing the transportation service. This dispatch code may be sent to the mobile device as part of the taxi ordering confirmation process. The dispatch code may be entered manually by a dispatcher or automatically by a corresponding automated dispatch system. The dispatch code may contain an identifier of the taxi or taxi driver, or it may be associated with an identifier of the taxi or taxi driver via a lookup table stored on a server. As the smart phone's redeem application is being run, and if there is an appropriate dispatch code available, the identifier of the taxi or taxi driver which is associated with that dispatch code may be used to direct payment.

Additionally the member has the option to share reward points with other members or non-members. Sharing may comprise entering the recipient's mobile phone number and selecting a specific amount of reward points to share and an identity of the point recipient. The recipient receives a SMS message on their mobile phone stating the sender's name and reward point amount. Alternatively, sharing may comprise invoking a social networking application and entering a desired username or other identifier of a social networking contact and an amount of reward points to share. The social networking contact will then receive a message via their social networking application indicating that reward points have been shared with them. If the person receiving the reward points is not yet a reward program member, they will be prompted to sign up for an account to use the reward points.

Finally all reward program partners and members can access their secure profile via a web browser to view, change or update their account information at any time.

### Example 2

A mobile device may be configured in accordance with an embodiment of the present technology via an application installed thereon. A main menu of the application includes a reward points balance and providing access to other views. The application may further have an interactive screen for managing input of reward codes. The application may further have an interactive screen for specifying an amount of collected reward points to redeem. The application may further have an interactive screen for specifying an identification code of a taxi driver associated with the points redemption. The application may further have an interactive screen from which a participating partner taxi can be called. The application may further have an interactive screen from which account options may be set. The application may further have an interactive screen from which sharing of reward points may be initiated. The application may further have an interactive screen from which further options may be set.

It will be appreciated that, although specific embodiments have been described herein for purposes of illustration, various modifications may be made without departing from the spirit and scope of the invention. In particular, it is within the scope of the invention to provide a computer program product or program element, or a program storage or memory device such as a transmission medium, magnetic or optical wire, tape or disc, or the like, for storing signals readable by a machine, for controlling the operation of a computer according to the method of the invention and/or to structure its components in accordance with the system of the invention. For example, a computer readable storage medium or a non-transitory storage medium may be provided in one or more implementations described herein.

Further, each step of the methods may be executed on a general computer, such as a personal computer, server or the like and pursuant to one or more, or a part of one or more, program elements, modules or objects generated from any programming language, such as Ruby, C, C++, Java, Perl, PL/1, or the like. In addition, each step, or a file or object or the like implementing each said step, may be executed by special purpose hardware or a circuit module designed for that purpose.

It is obvious that the foregoing embodiments of the technology are examples and can be varied in many ways. All such modifications as would be obvious to one skilled in the art are intended to be included within the scope of the following claims.

We claim:

1. A method for generating consumer loyalty incentives for distribution from a point of sale following registration of a transaction involving a consumer and a first party, the method comprising:
extracting, at least in part via a point of sale (POS) terminal, information associated with the transaction;
obtaining a reward program member identifier;
generating reward points based on the extracted information; and
crediting the reward points to an online account associated with the reward program member identifier, the reward points redeemable during another transaction at another point of sale by the consumer or by a registered reward program member to whom the consumer has transferred at least a portion of the reward points,
wherein one or more of: obtaining the reward program member identifier, generating the reward points, and crediting the reward points to the online account comprise interaction with a mobile device associated with the consumer.

2. The method according to claim 1, wherein generating the reward points comprises:
generating a substantially unique incentive code based at least in part on said extracted information;
providing the incentive code for collection by the consumer via the POS terminal; and
prompting for and receiving the incentive code on the mobile device, the incentive code entered by the consumer,
wherein the reward program member identifier is provided via the mobile device.

3. The method according to claim 2, wherein generation of the substantially unique incentive code is performed at the POS terminal or at a remote server.

4. The method according to claim 1, wherein the consumer is a registered reward program member, the method further comprising:
automatically detecting the presence of the mobile device carried by the reward program member, the mobile device carrying reward program registration information;
automatically obtaining the reward program member identifier from the mobile device;
automatically associating the obtained reward program member identifier with the transaction based at least in part on determination that a location of the mobile device corresponds with the transaction; and
transmitting the extracted information to a remote server, wherein the extracted information comprises the reward program member identifier and an indication of at least one of a value of the transaction and a number of reward points to be credited to the member.

5. The method according to claim 1, further comprising transferring at least a portion of the reward points to said registered reward program member.

6. The method according to claim 1, wherein the transaction includes a purchase of at least one of food or beverage by the consumer, and wherein said other point of sale is associated with a transportation provider.

7. The method according to claim 6, wherein the transaction includes a purchase of at least one alcoholic beverage for on-site consumption by the consumer, the method thereby incentivizing responsible consumption of alcohol by the consumer.

8. The method according to claim 1, the method further comprising: on request of a user, automatically performing a second transaction, the second transaction comprising redeeming a second number of reward points toward a payment to a second party, the second number of reward points redeemed from the account or from another account to which the second number of reward points have been transferred from the account.

9. A method for redeeming electronically stored reward points, the method comprising:
providing a user access, via a mobile device, to a reward points account held on a server;
obtaining, at the mobile device, an indication of a party involved in a transaction with the user and to whom the payment is due;
receiving an instruction, on the mobile device, to make a payment to said party in a designated amount;
prompting for and receiving a user selection, via the mobile device, of a number of reward points stored in the account to be used for redemption toward the payment;
debiting the selected number of reward points from the account; and
initiating said payment of said designated amount to said party.

10. The method according to claim 9, wherein initiating said payment comprises identifying a recipient account of said party based at least in part on the identification code, and crediting the recipient account with monetary value in said designated amount.

11. The method according to claim 9, wherein the number of reward points to be used for redemption correspond to a monetary value which is less than the designated amount of the payment, the method further comprising drawing on a further source of user designated funds or credit to provide for the difference between said designated amount and said monetary value.

12. The method according to claim 11, wherein the further source of user designated funds is a telecom carrier mobile payment system.

13. The method according to claim 9, further comprising generating and transmitting a confirmation message from the server to a second mobile device associated with said party, the confirmation message indicative that said payment has been made.

14. The method according to claim 9, wherein obtaining the indication comprises prompting for and receiving user entry of an identification code indicative of the party involved in the transaction.

15. The method according to claim 9, wherein obtaining the indication comprises:
establishing a wireless communication link between the mobile device and a computer aided dispatch system associated with said party; and
confirming at the mobile device that the computer aided dispatch system is associated with the party involved in the transaction with the user.

16. The method according to claim 15, wherein initiating said payment comprises wirelessly transmitting payment information to the computer aided dispatch system.

17. The method according to claim 9, wherein the mobile device is used to initiate a product or service ordering process associated with the transaction prior to making the payment, the indication of the party involved in the transaction obtained during the ordering process and stored in computer memory, and wherein obtaining the indication comprises retrieving the indication from memory.

18. The method according to claim 9, wherein at least a portion of the reward points have been transferred to the account from another account.

19. A system for generating consumer loyalty incentives for distribution from a point of sale following registration of a transaction involving a consumer and a first party, the system comprising an incentive generation module configured to:
extract, at a point of sale (POS) terminal, information associated with the transaction;
obtain a reward program member identifier;
generate reward points based on the extracted information; and
credit the reward points to an online account associated with the reward program member identifier, the reward points redeemable during another transaction at another point of sale by the consumer or by a registered reward program member to whom the consumer has transferred at least a portion of the reward points,
wherein the incentive generation module is configured to interact with a mobile device associated with the consumer in performing one or more of: obtaining the reward program member identifier, generating the reward points, and crediting the reward points to the online account.

20. The system according to claim 19, wherein the incentive generation module is further configured to:
generate a substantially unique incentive code based at least in part on said extracted information;
provide the incentive code for collection by the consumer via the POS terminal; and
prompt for and receive the incentive code on the mobile device as operated by the consumer,
wherein the reward program member identifier is provided via the mobile device.

21. The system according to claim 19, wherein the consumer is a registered reward program member, the incentive generation module further configured to:
automatically detect the presence of the mobile device carried by the reward program member;
automatically obtain the reward program member identifier from the mobile device, the mobile device carrying reward program registration information;
automatically associate the obtained reward program member identifier with the transaction based at least in part on determination that a location of the mobile device corresponds with the transaction; and
transmit the extracted information to a remote server; wherein the extracted information comprises the reward program member identifier and an indication of one or both of: a value of the transaction and a number of reward points to be credited to the member.

22. The system according to claim 19, further comprising an incentive redemption module configured, on request of a user, to automatically perform a second transaction, the second transaction comprising redeeming a second number of reward points toward a payment to a second party, the second number of reward points redeemed from the account or from another account to which the second number of reward points have been transferred from the account.

23. The system according to claim 19, further comprising an incentive redemption module configured to:
provide a user access, via a mobile device, to the reward points held in a remote account;
obtain, at the mobile device, an indication of a party involved in a transaction with the user and to whom the payment is due;
receive an instruction, on the mobile device, to make a payment to said party in a designated amount;
prompt for and receiving a user selection, via the mobile device, of a number of reward points stored in the account to be used for redemption toward the payment;
debit the selected number of reward points from the account; and
initiate said payment of said designated amount to said party.

24. The system according to claim 23, wherein obtaining the indication comprises prompting for and receiving user entry of an identification code indicative of the party involved in the transaction.

25. The system according to claim 23, wherein obtaining the indication comprises:
establishing a wireless communication link between the mobile device and a computer aided dispatch system associated with said party; and
confirming at the mobile device that the computer aided dispatch system is associated with the party involved in the transaction with the user.

26. The system according to claim 23, wherein the mobile device is used to initiate a product or service ordering process associated with the transaction prior to making the payment, the indication of the party involved in the transaction obtained during the ordering process and stored in computer memory, and wherein obtaining the indication comprises retrieving the indication from memory.

27. A computer program product comprising a computer readable memory storing computer executable instructions thereon that when executed by a computer perform operations for generating consumer loyalty incentives for distribution from a point of sale following registration of a transaction involving a consumer and a first party, the operations comprising:
extracting, at least in part via a point of sale (POS) terminal, information associated with the transaction;
obtaining a reward program member identifier;
generating reward points based on the extracted information; and
crediting the reward points to an online account associated with the reward program member identifier, the reward points redeemable during another transaction at another point of sale by the consumer or by a registered reward program member to whom the consumer has transferred at least a portion of the reward points,
wherein one or more of obtaining the reward program member identifier, generating the reward points, and crediting the reward points to the online account comprise interaction with a mobile device associated with the consumer.

28. A computer program product comprising a computer readable memory storing computer executable instructions thereon that when executed by a computer perform operations for redeeming electronically stored reward points, the operations comprising:
providing a user access, via a mobile device, to a reward points account held on a server;
obtaining, at the mobile device, an indication of a party involved in a transaction with the user and to whom the payment is due;
receiving an instruction, on the mobile device, to make a payment to said party in a designated amount;
prompting for and receiving a user selection, via the mobile device, of a number of reward points stored in the account to be used for redemption toward the payment;
debiting the selected number of reward points from the account; and
initiating said payment of said designated amount to said party.
